(19) United States
(12) Patent Application Publication
(10) Pub. No.: US 2010/0296423 A1
(43) Pub. Date: Nov. 25, 2010

(54) Multi-Medium Signal Transmission System and Method

(75) Inventor: Gill Heydari, Menlo Park, CA (US)

Correspondence Address: Aram Ayrapetian, 17490 Calle Mazatan, Morgan Hill, CA, 95037, US

(73) Assignee: Greenlane Investments LLC, Los Altos Hills, CA (US)

(21) Appl. No.: 12/782,703

(22) Filed: May 18, 2010

Related U.S. Application Data
(60) Provisional application No. 61/179,703, filed on May 19, 2009.

(51) Int. Cl. H04L 29/02; H04B 7/00

(52) U.S. Cl. 370/310; 370/464

(57) ABSTRACT

A system and method are provided for transmitting and receiving a data stream through multiple paths in different mediums. A data stream can be demuxed into separate sub-streams and the separate sub-streams can be communicated to a device through different mediums, where the separate sub-streams can be muxed into a single substream at the receiving device. For example, one sub-stream can be conveyed wirelessly through an antenna, or through several antennas via MIMO transmission, and one sub-stream can be conveyed through a wire medium, such as a telephone line or a power line. Various pre-processing techniques, such as STBC encoding, FEC encoding, and MIMO matrix encoding as well as different methods of demuxing can be implemented to improve reliability and throughput of the system.

### CLAIM OF PRIORITY

This application claims the benefit of U.S. Provisional Patent Application No. 61/179,703 entitled “MULTI-MEDIUM MULTI INPUT MULTI OUTPUT (MIMO) SYSTEM BETWEEN WIRELESS AND OTHER MEDIUMS SUCH AS POWER LINE” by Gill Heydari, filed on May 19, 2009, the disclosure of which is incorporated by reference herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates generally to the field of communication technology, and more specifically to data transfer in wireless and wire mediums involving multiplexing and transmission over multiple paths such as MIMO transmission.

### BACKGROUND

In the age of information, the field of data communication has become among the most important areas of technology. As society becomes more and more reliant on fast and consistent access to information, manufacturers of network devices are challenged to provide high-volume, reliable rates of data transfer at low cost.

Generally, communications systems include a transmitter communicating data to a receiver over a communications channel or a communications medium. For example, a router can communicate with a personal computer to provide internet access to the personal computer. The router can communicate with the computer wirelessly, through an antenna, or through a wire, such as an Ethernet cable.

The throughput and reliability of a data communication system is highly influenced by the medium and the channel through which the data is conveyed. Certain mediums, such as fiber optics and coaxial cable, can provide high-throughput, reliable data transfer; however, utilizing such mediums is not always possible. For example, such mediums may not be available at a location. Alternatively, such mediums may not be useable due to application requirements, such as mobility. Other mediums, such as wireless and power line, are more readily available and ubiquitous in application but can exhibit lower levels of performance.

In today's world, a multitude of mediums, such as power line, wireless, phone line, coaxial cable, and others can be available at a single location. However, existing devices only exploit a single medium as a communications pathway to another device. What is needed is a system and method to intelligently combine available mediums at a location to provide a communications pathway with higher throughput and reliability.

### BRIEF DESCRIPTION OF THE DRAWINGS

FIG. 1A illustrates an example of a transmitter communicating with a receiver over a wireless path and a wire path.

FIG. 1B illustrates an example of a transmitter communicating with a receiver over multiple wireless paths and multiple wire paths.

FIG. 1C illustrates a transmitter that is configurable to convey a sub-stream through a wireless or a wire medium.

FIG. 2 illustrates an example of a transmitter in accordance with various embodiments of the invention.

FIG. 3 is a process flow illustration of a transmitter's processes in accordance with various embodiments.

FIG. 4 illustrates an example of a receiver in accordance with various embodiments.

FIG. 5 is a process flow illustration of a receiver's processes in accordance with various embodiments.

FIG. 6 illustrates an example of a cross-medium pre-processing module in accordance with various embodiments.

FIG. 7 illustrates an example of a cross-medium post-processing module in accordance with various embodiments.

FIG. 8 illustrates an example of a transmitter where a data stream can be optionally transmitted through a wireless medium or a wire-line medium.

FIG. 9 illustrates an example of a transmitter where a data stream can be optionally received through a wireless medium or a wire-line medium.

FIG. 10 illustrates an example of communication bridging between various devices, in accordance with various embodiments.

### DETAILED DESCRIPTION

In the following description, numerous specific details are set forth in order to provide a thorough understanding of the present invention. However, it will be apparent to one skilled in the art that the present invention can be practiced without these specific details. In other instances, well known circuits, components, algorithms, and processes have not been shown in detail or have been illustrated in schematic or block diagram form in order not to obscure the present invention in unnecessary detail. Additionally, for the most part, details concerning communication systems, transmitters, receivers, communication devices, and the like have been omitted inasmuch as such details are not considered necessary to obtain a complete understanding of the present invention and are considered to be within the understanding of persons of ordinary skill in the relevant art. It is further noted that, where feasible, all functions described herein may be performed in either hardware, software, firmware, digital components, or analog components or a combination thereof, unless indicated otherwise. Certain term are used throughout the following description and Claims to refer to particular system components. As one skilled in the art will appreciate, components may be referred to by different names. This document does not intend to distinguish between components that differ in name, but not function. In the following discussion and in the Claims, the terms “including” and “comprising” are used in an open-ended fashion, and thus should be interpreted to mean “including, but not limited to . . . ”

Embodiments of the present invention are described herein. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with applications and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In the following specification and claims, the term “data stream” and “signal” are used interchangeably to refer to any data that is transferrable between devices and are not intended to be interpreted in a limiting sense.

In various embodiments, systems and methods are described for transmitting a data stream over multiple transmission paths. A data stream can be received in a transmitter and segregated, or separated, into multiple data streams in a demultiplexer or demux. The multiple data streams can be communicated to a receiver or several receivers in another device over separate paths. In the device, the multiple data streams can be desegregated, or combined, into a single data stream in a component such as a multiplexer or mux. In various embodiments, the multiple paths can comprise wireless paths and wire paths. Wireless paths can comprise a transmission over the air between a transmitter antenna and a receiver antenna. In various embodiments, wireless transmission can be MIMO transmission, SIMO transmission, and/or MISO transmission. Wire paths can comprise any wire lines including but not limited to power lines, telephone lines, and coaxial cabling. In various embodiments, a signal can be demuxed and the produced sub-streams can be conveyed down any combination of wireless and wire paths.

Where feasible, any device that communicates data to another device can comprise an architecture in accordance with various embodiments of the invention. For example, data transfer to and from home networking devices such as routers, laptops, personal computers, TVs, DVRs, storage devices and myriad others can be performed according to embodiments described herein. More specifically, for example, data between a router and a laptop can be transferred through a combination of wireless mediums and wire mediums such as power line and/or telephone line.

Hence, in various embodiments, a data stream can be demuxed and conveyed through a combination of wireless and wire mediums. For example, a data stream can be demuxed into four separate streams, three of the sub-streams can be conveyed wirelessly through wireless MIMO transmission and one sub-stream can be conveyed through a power line, a phone line, or a coax line. In another example, a data stream can be demuxed into four separate sub-streams, two of the sub-streams can be conveyed wirelessly through wireless MIMO transmission, one sub-stream can be conveyed through a power line, and one sub-stream can be conveyed through a telephone line.

Generally, demuxing involves separating a data stream into sub-streams to achieve a greater throughput in multiple channels and preserve signal quality. Demuxing can be performed to separate a data stream between separate paths in one medium, between separate paths in different mediums, or between separate paths in different mediums with more than one separate path in a single medium. In various embodiments, demuxing can include separating a data stream into pieces of data and conveying the pieces of data down separate sub-streams. For example, demuxing can comprise a basic round robin distribution of data based on the capacity of each medium. In order to introduced flexibility and agility in demuxing data, data can be sent in packets to one path at a time and each packet can be labeled by a sequence number such that the packets can be easily re-assembled at the receiver. This can allow for each path to be individually managed based on the delay and reliability in the path.

For example, if a stream is to be separated into three data sub-streams, then a first packet of data can be conveyed to the first sub-stream; the second packet of data to the second sub-stream; the third packet of data to the third sub-stream; the forth packet of data to the first sub-stream, and so on. Alternatively, data can be separated by bits; for example, all odd data bits can be conveyed in one stream and all even data bits can be conveyed in another stream.

In various embodiments, demuxing can include separating data based on other parameters. For example, for a video file, an audio stream can be conveyed through one path and the image file can be conveyed through another path. Furthermore, in various embodiments, the system can be configured to separate and convey sub-streams according to path properties. For example, if one of a multiple transmission paths has a slower throughput rate, then the data stream demuxing can be performed so that a correspondingly lower volume of data is conveyed down the slower path than the faster paths.

In various embodiments, demuxing can comprise repeating a data stream and sending an identical copy of the data stream down separate paths. Sending identical copies of the data stream on separate paths can provide more reliability by lowering the chances of the signal getting lost. Such transmission can produce favorable results in communication in lower signal-to-noise-ratio environments by increasing reliability.

Numerous techniques exist and are well known in the art for demuxing a data stream into sub-streams before transmitting the data and muxing the sub-streams into a single data stream when the sub-streams are received. The various techniques will not be covered in detail here as the specifics of demuxing and muxing are not necessary to obtain a complete understanding of the invention.

In various embodiments, before a signal is demuxed, it can be pre-processed. Pre-processing across different mediums (cross-medium pre-processing) can achieve throughput that may be greater than can be otherwise achieved through combination of multiple paths. Generally, pre-processing can comprise any technique for conditioning a signal to improve performance such as throughput, quality, and/or reliability in transmission. Such techniques may be specifically applicable to multi-path transmission or they may be applicable to both single-path and multi-path transmission. For example, any of Forward Error Correction (FEC) encoding, Space-Time Block Coding (STBC), MIMO matrix encoding and other pre-processing method or a combination thereof can be performed prior to demuxing. Also, as will be described in further detail below, a device can be configurable to select what pre-processing techniques to implement. Similarly, after received sub-streams are muxed, any of Forward Error Correction (FEC) decoding, Space-Time Block Coding (STBC) decoding, MIMO matrix decoding and other post-processing method or a combination thereof can be performed to process the transmitted data. Also, as will be described in further detail below, a device can be configurable to select what post-processing techniques to implement. Numerous techniques exist and are well known in the art for pre-processing a data stream and post-processing a data stream and will not be covered in detail here as the specifics of pre-processing and post-processing are not necessary to obtain a complete understanding of the invention.

According to various embodiments, multi-medium transmission can result in more reliable transfer of data. For example, by communicating information over different mediums, such as air and wire, diversity in path conditions can improve reliability of data transmission. For instance, because wireless transmission and wire transmission are affected by independent noise sources, an event in the environment that affects one transmission path may not affect the other transmission path.

According to various embodiments, multi-medium transmission can result in improved data throughput. For example, multiple, non-overlapping and non-conflicting channels in different mediums can be available for communicating data, allowing for high data throughput. Further, a higher data throughput can translate to higher reliability.

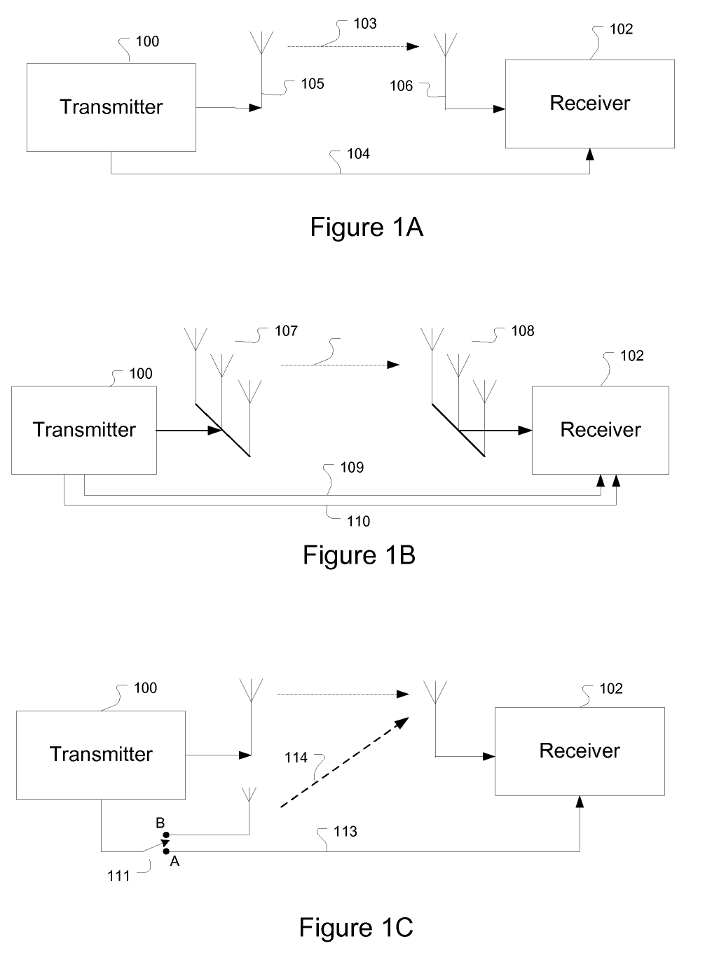

FIG. 1A illustrates an example of a transmitter communicating with a receiver over a wireless path and a wire path. As illustrated in the example, a transmitter 100 can transmit a data stream to a receiver 102 through a wireless medium 103 and a wire medium 104. For example, the transmitter 100 can be located in a router and the receiver 102 can be located in a laptop computer. The transmitter can convey a first data sub-stream to an antenna 105, which data sub-stream can be communicated to the receiver 102 through an antenna 106 on the receiver. The transmitter 100 can communicate a second data sub-stream to the receiver 102 through the wire medium 104. In various embodiments, the wire medium 104 can be any type of wire medium such as telephone line, coax cable, or power line.

In various embodiments, the wireless transmission between the transmitter 100 and the receiver 102 can be either multiple in multiple out (MIMO) transmission, single in multiple out (SIMO) transmission, multiple in single out (MISO) transmission, or single in single out (SISO) transmission. In various embodiments, the transmitter 100 and the receiver 102 can communicate through more than one wire path, for example a power line and a telephone line.

FIG. 1B illustrates an example of a transmitter communicating with a receiver over multiple wireless paths and multiple wire paths. As illustrated in the example, a transmitter 100 can convey three data sub-streams through three antennas 107 to be received by three antennas 108 at the receiver 102. The transmitter 100 can convey a sub-stream through one wire medium 109 and another sub-stream through another wire medium 110. For example, one wire medium 109 can be a telephone line and another wire medium 110 can be a power line.

In various embodiments, the invention can be configured so that if a wire line is not available or not desired, then the sub-stream that would otherwise be conveyed through the wire line can be conveyed wirelessly. Similarly, the invention can be configured so that if a wireless path is not available or not desired, then the sub-stream that would otherwise be conveyed through the wireless path can be conveyed through a wire line.

FIG. 1C illustrates a transmitter that is configurable to convey a sub-stream through a wireless or a wire medium. In the illustrated example, a transmitter 100 can convey a sub-stream to a switch 111, when the switch is closed on position “A”, the sub-stream can be conveyed through a wire line medium 113. When the switch is closed in position B, the sub-stream can be conveyed through a wireless medium 114.

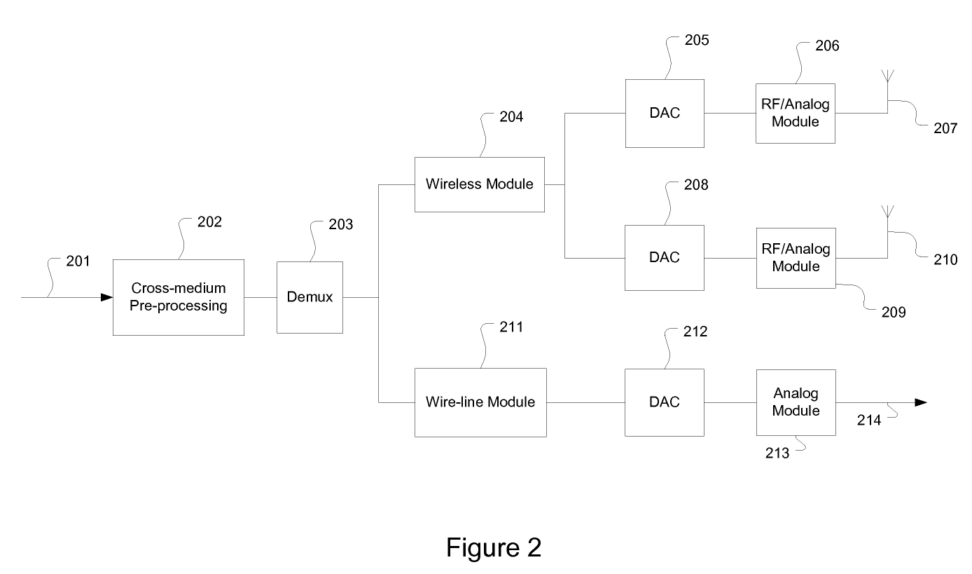

FIG. 2 illustrates an example of a transmitter in accordance with various embodiments of the invention. A data stream 201 can be conveyed to a cross-medium pre-processing module 202, where the data stream can be cross-medium pre-processed as described above. From the pre-processing module 202, the signal can be conveyed to a demux 203, where the stream can be segregated into two sub-streams as described above. One sub-stream can be conveyed to a wireless module 204, where the sub-stream can be processed for wireless transmission by performing, for example, various baseband modulation techniques and signal conditioning methods, filtering, and/or sampling rate conversions. In various embodiments, the wireless module 204 may possess an up-conversion block where the center frequency of the signal is converted from baseband to an intermediate frequency (IF). In the wireless module 204, the signal can be demuxed into two sub-streams. The demuxing in the wireless module 204 can be performed based on a relative ratio calculated based on the estimated throughput capacity of each medium. From the wireless module 204, one sub-stream can be conveyed to a digital to analog converter (DAC) 205 for analog conversion. The analog sub-stream can be conveyed to an RF/Analog module 206, where the signal can be filtered, amplified, up-converted to its intended transmission radio frequency (RF), and/or otherwise processed further before it is conveyed to an antenna 207 to be communicated over the air. The second sub-stream produced in the wireless module 204 can conveyed to a digital to analog converter (DAC) 208 for analog conversion. The analog sub-stream can be conveyed to an RF/Analog module 209, where the signal can be filtered, amplified, up-converted to its intended transmission radio frequency (RF), and/or otherwise processed further before it is conveyed to an antenna 210 to be communicated over the air. The second sub-stream produced in the demux 203 can be conveyed to a wire-line module 211 where the signal can be processed for wire transmission by performing, for example, baseband modulation, filtering, and/or sampling rate conversions. From the wire-line module 211, the signal can be conveyed to a DAC 212 and to an analog module 213, where the signal can be filtered, amplified, and/or otherwise further processed before it is communicated from the transmitter through a wire medium 214. In various embodiments, the wire medium can be a telephone line, a coaxial cable, or a power line. Although the embodiments illustrated in FIG. 2 illustrate transmission of only one data stream through a wire path, in other embodiments, multiple data streams can be conveyed through multiple corresponding wire paths.

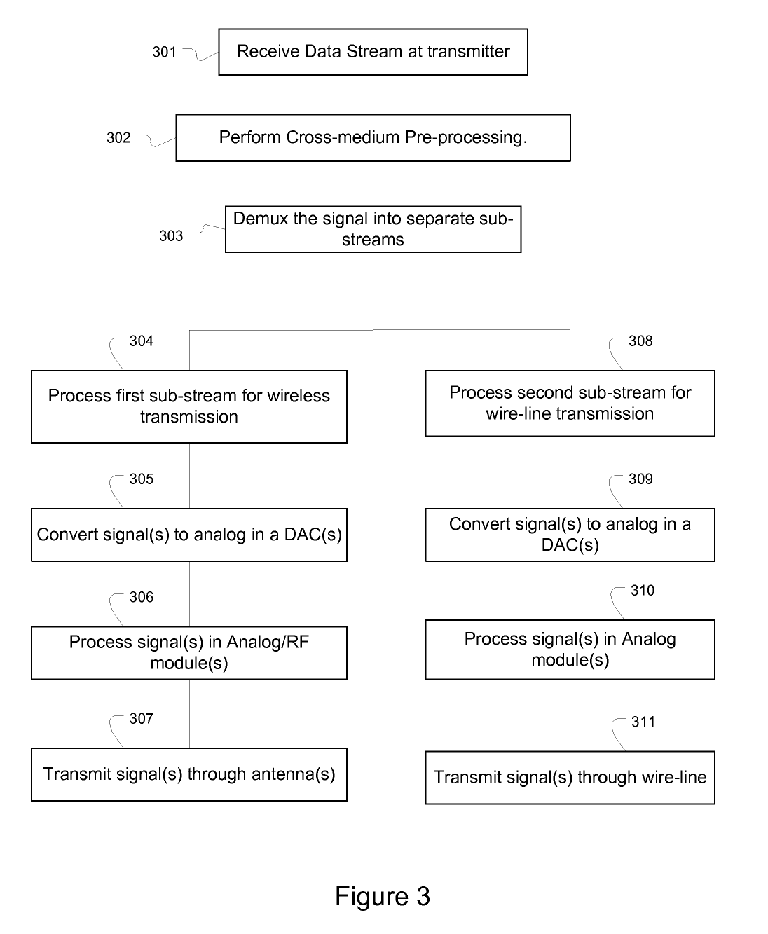

FIG. 3 is a process flow illustration of a transmitter's processes in accordance with various embodiments. A data stream intended for transmission can be received at the transmitter 301. Cross-medium pre-processing 302 can be performed on the data stream as described above.

The signal can be demuxed into separate data sub-streams 303 in a demuxer as described above. One sub-stream can be processed 304 in a wireless baseband module to prepare the signal for wireless transmission by performing, for example, modulation, filtering, amplification, sampling rate conversion, and/or frequency tuning. If transmission through more than one wireless path is desired, the signal can be demuxed and further processed for multi-path transmission, such as by MIMO matrix encoding, in the processing 304. The signal or signals can be converted to the analog domain 305 in a DAC or DACs. The analog signal(s) can be further processed 306 in a RF/Analog module(s) to amplify, filter, and/or change the center frequency of the signal. The signal(s) can be transmitted 307 through an antenna or antennas. The second data sub-stream can be processed 308 in a wire-line baseband module to prepare the signal for wire-line transmission by performing, for example, modulation, filtering, amplification, sampling rate conversion, and/or frequency tuning. If transmission through more than one wire-line path is desired, the signal can be demuxed and further processed for multi-path transmission, such as by MIMO matrix encoding, in the processing 308. The signal or signals can be converted to the analog domain 309 in a DAC or DACs. The analog signal(s) can be further processed 310 in an Analog module(s) to amplify, filter, and/or change the center frequency of the signal(s). The signal(s) can be transmitted 311 through a wire medium such as coax, telephone line, or power-line.

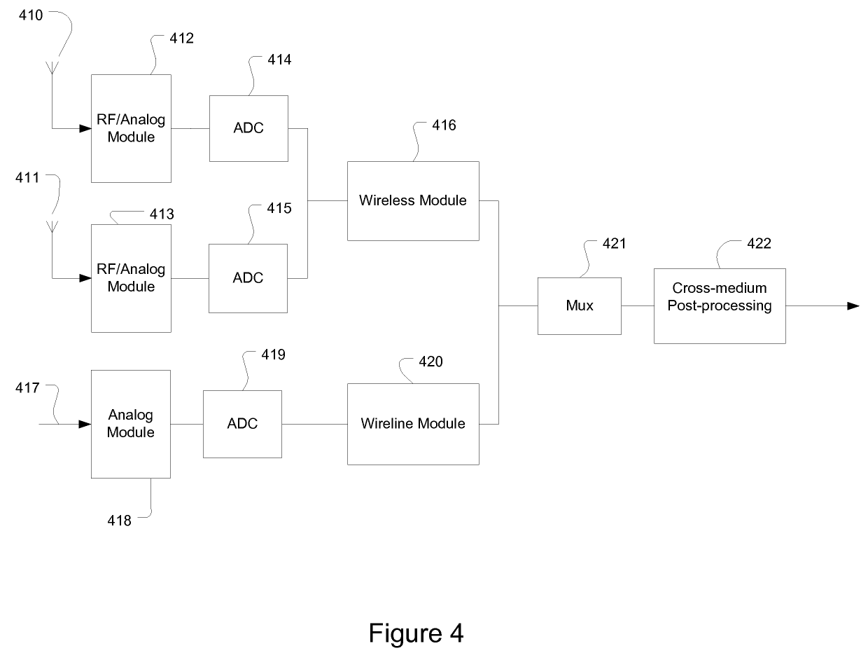

FIG. 4 illustrates an example of a receiver in accordance with various embodiments. A first data stream can be received at an antenna 410 and conveyed to an RF/Analog module 412 where the data stream can be processed, for example it can be amplified, filtered, and/or tuned. The data stream can be conveyed to an analog to digital converter (ADC) 414. A second data stream can be received at an antenna 411 and conveyed to an RF/Analog module 413 where the data stream can be processed, for example it can be amplified, filtered, and/or tuned. The data stream can be conveyed to an analog to digital converter (ADC) 415. The two data streams can be conveyed to a wireless module 416 to be processed, for example through demodulation, baseband processing, filtering, amplification, and/or muxing. A third data stream 417 from an analog medium can be conveyed to an analog module 418 to be processed, for example by filtering, amplification, and/or tuning. The data stream can be conveyed to an ADC 419 and to a wire-line module 420 to be further processed, for example with demodulation, baseband processing, filtering, and/or amplification. The data streams from the wireless module 416 and the data stream from the wire-line module 420 can be conveyed to a mux 421 to be combined into a single data stream as described above. The single data stream can be conveyed to cross-medium post-processing module 422 for further processing such as FEC decoding, STBC demodulation, and/or MIMO matrix demodulation. Although in the embodiment illustrated in FIG. 4 only one data stream is received through a wire path, in other embodiments, multiple data streams can be received through multiple corresponding wire paths.

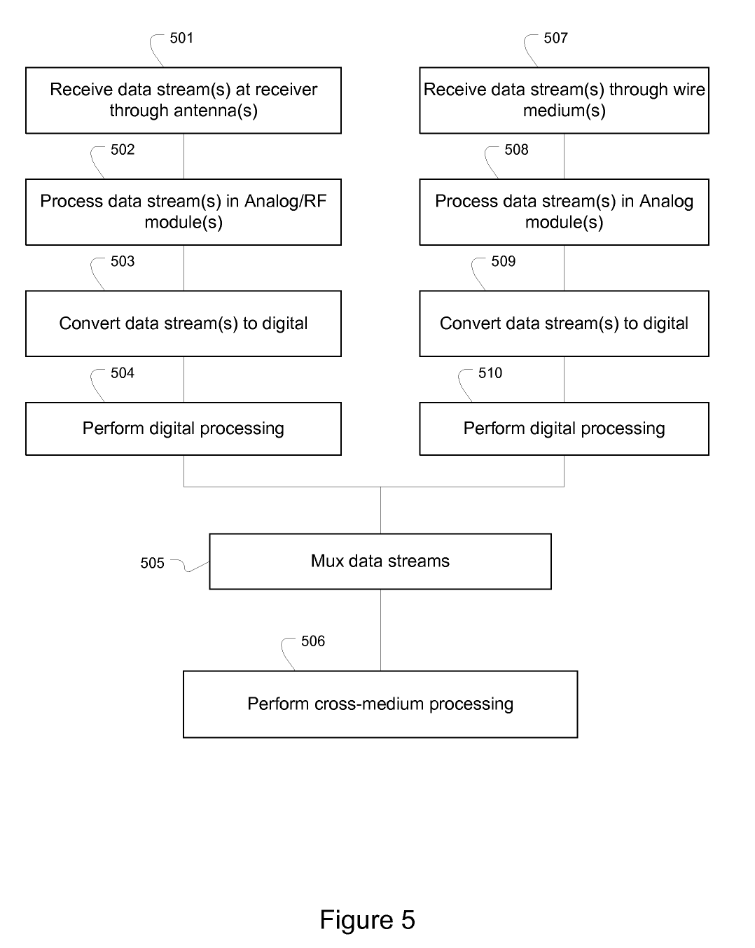

FIG. 5 is a process flow illustration of a receiver's processes in accordance with various embodiments. A data stream or data streams can be received 501 through one or more antennas at the receiver. The stream(s) can be processed 502 in a RF/Analog module(s) to process the stream, for example by amplifying, filtering, and/or changing the center frequency of the data stream(s). The data stream(s) can be converted 503 to the digital domain in DAC(s). The digital streams(s) can be digitally processed 504, for example to demodulate the signal(s). A data stream or data streams can be received 507 through one or more wire mediums at the receiver. The wire-line data stream(s) can be processed 508 in Analog module(s), for example, to amplify, filter, and/or change the center frequency of the stream(s). The stream(s) can be converted 509 to the digital domain in DAC(s). The digital stream(s) can be digitally processed 510, for example to demodulate the signal(s). The data streams can be muxed 505 in a mux to produce a single data stream, as described above. The produced stream can be cross-medium processed 506 as described above before being conveyed to other portions of the device.

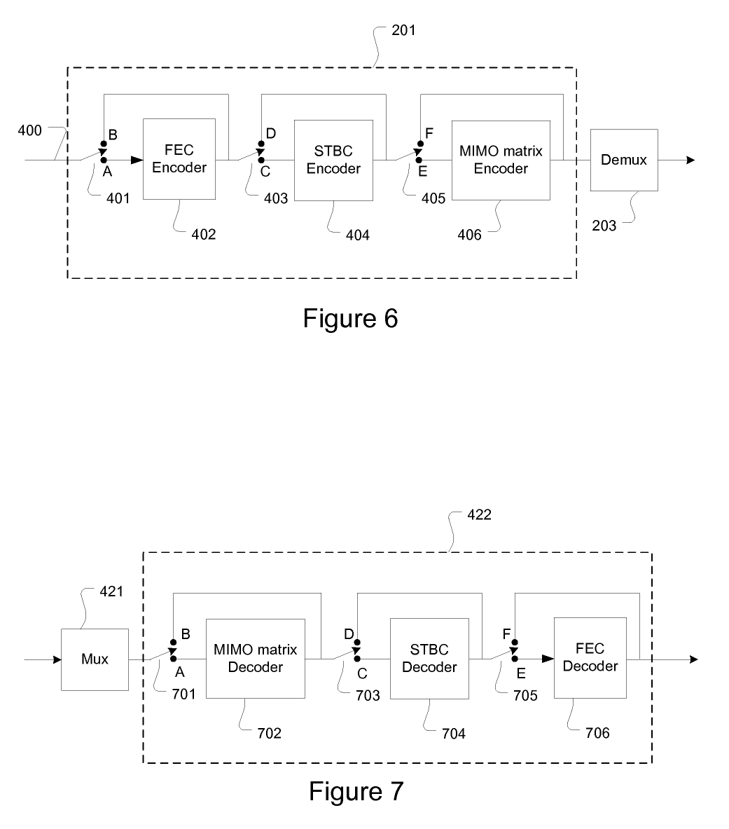

FIG. 6 illustrates an example of a cross-medium pre-processing module in accordance with various embodiments. The example pre-processing module 201 illustrated in the figure can be located in a transmitter to process a data stream before the data stream is conveyed to a demux 203, such as in the example illustrated in FIG. 2. The pre-processing module 201 illustrated in the example can be configured to perform FEC encoding, STBC encoding, MIMO matrix encoding or any combination thereof by configuring switches 401, 403, and 405. Such a module can allow a device to select which encoding techniques to implement when a particular set of encoding techniques is desired. As illustrated in the figure, a data stream 400 can be conveyed to the pre-processing module 201. In the pre-processing module 201, the data stream can be conveyed to a first switch 401. If the switch 401 is closed on position “A”, then the data stream can be conveyed to an FEC encoder 402, if the switch 401 is closed on position “B”, then the data stream can be conveyed to the second switch 403, bypassing the FEC encoder 402. If the second switch 403 is closed on position “C”, then the data stream can be conveyed to an STBC encoder 404, if the switch is closed on position “D”, then the data stream can be conveyed to the third switch 405, bypassing the STBC encoder 404. If the third switch 405 is closed on position “E”, then the data stream can be conveyed to a MIMO matrix encoder 406, if the switch is closed on position “F”, then the data stream can be conveyed out of the pre-processing module 201 to the demux 203, bypassing the MIMO matrix encoder 406.

FIG. 7 illustrates an example of a cross-medium post-processing module in accordance with various embodiments. As illustrated in the example of the figure, a post-processing module 422 can process a data stream conveyed from a mux 421, such as in the example illustrated in FIG. 4. The post-processing module 422 illustrated in the example can be configured to perform FEC decoding, STBC decoding, MIMO matrix decoding or any combination thereof by configuring switches 701, 703, and 705. Such a module can allow a device to select which decoding techniques to implement when a particular set of decoding techniques is desired. In the post-processing module 422, the data stream can be conveyed to the first switch 701. If the switch 701 is closed on position “A”, then the data stream can be conveyed to a MIMO matrix decoder 702, if the switch is closed on position “B”, then the data stream can be conveyed to the second switch 703, bypassing the MIMO matrix decoder 702. If the second switch 703 is closed on position “C”, then the data stream can be conveyed to an STBC decoder 704, if the switch is closed on position “D”, then the data stream can be conveyed to the third switch 705, bypassing the STBC decoder 704. If the third switch 705 is closed on position “E”, then the data stream can be conveyed to an FEC decoder 706, if the switch 705 is closed on position “F”, then the data stream can be conveyed out of the pre-processing module 422, bypassing FEC decoder 706.

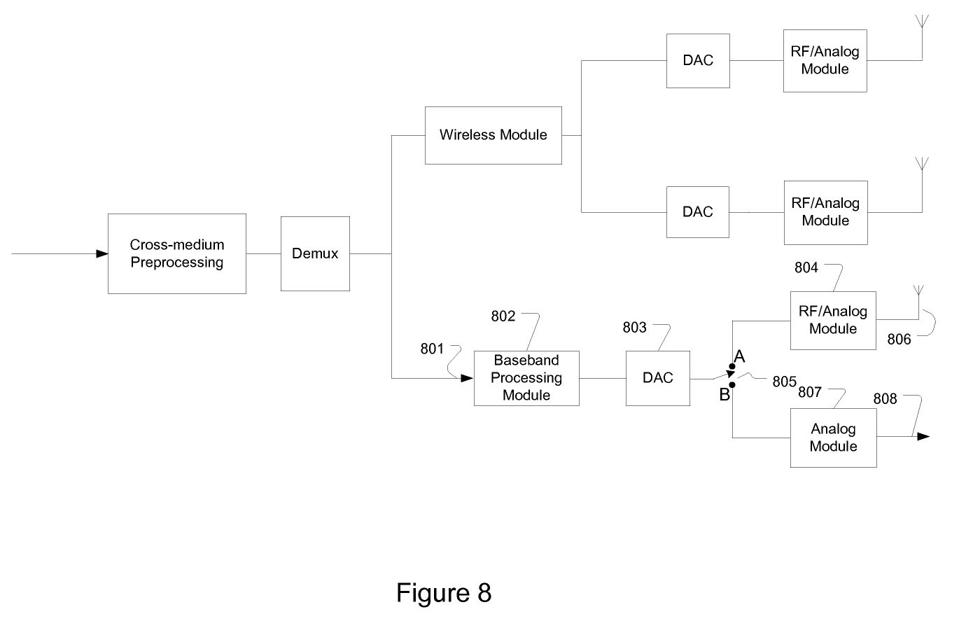

In various embodiments, the device can be configured so that a sub-stream in a transmitter can be transmitted down any one of a set of alternative paths. Such embodiments can have the advantage of allowing a data stream to be switched from one medium of transmission to another medium when one medium becomes more favorable than another. FIG. 8 illustrates an example of a transmitter where a data stream can be optionally transmitted through a wireless medium or a wire-line medium. The example of a transmitter that is configurable to convey a sub-stream through a wireless or a wire medium illustrated in FIG. 1C can comprise an architecture as illustrated in FIG. 8. In the illustrated example, the structure and function of components other than components 801 through 808 can be analogous to the corresponding components and functions described in FIG. 2. As illustrated in the example, a sub-stream 801 can be conveyed to a baseband processing module 802 where the signal can be processed by performing, for example, various baseband modulation techniques and signal conditioning methods, filtering, and/or sampling rate conversions. In various embodiments, the baseband module 802 can support multiple modulation techniques and signal conditioning methods to cover both wireless and wire-line transmission in various standards. In an embodiment, one baseband processing module can process the data stream for wireless transmission and another baseband processing module can process the data stream for wire-line transmission. In various embodiments, the baseband processing module 802 may possess an up-conversion block where the center frequency of the signal is converted from baseband to an intermediate frequency (IF), for example, in case of wireless transmission. The signal can be conveyed to a DAC 803 and to a switch 805. To convey the signal through a wireless medium, the switch 805 can be closed on position “A.” With the switch 805 in position “A”, the signal can be conveyed to a RF/Analog module 804 for wireless transmission processing. In the RF/Analog module 804, the signal can be, for example, filtered, amplified, up-converted to its intended transmission radio frequency (RF), and processed further before it is conveyed to an antenna 806 to be communicated over the air. To convey the signal through a wire-line medium, the switch 805 can be closed on position “B.” With the switch 805 in position “B”, the signal can be conveyed to an Analog module 807 for wire-line transmission processing where the signal can be, for example, filtered, amplified, and further processed before it is communicated from the transmitter through a wire medium 808 such as a telephone line, a coaxial cable, or a power line. In other embodiments, the device can be configured so that a data stream can be conveyed down one of several paths. For example, a five way switch can be used to direct a data stream either wirelessly using MIMO transmission, wirelessly using SISO transmission, through a telephone line, through a power line, or through a coax cable.

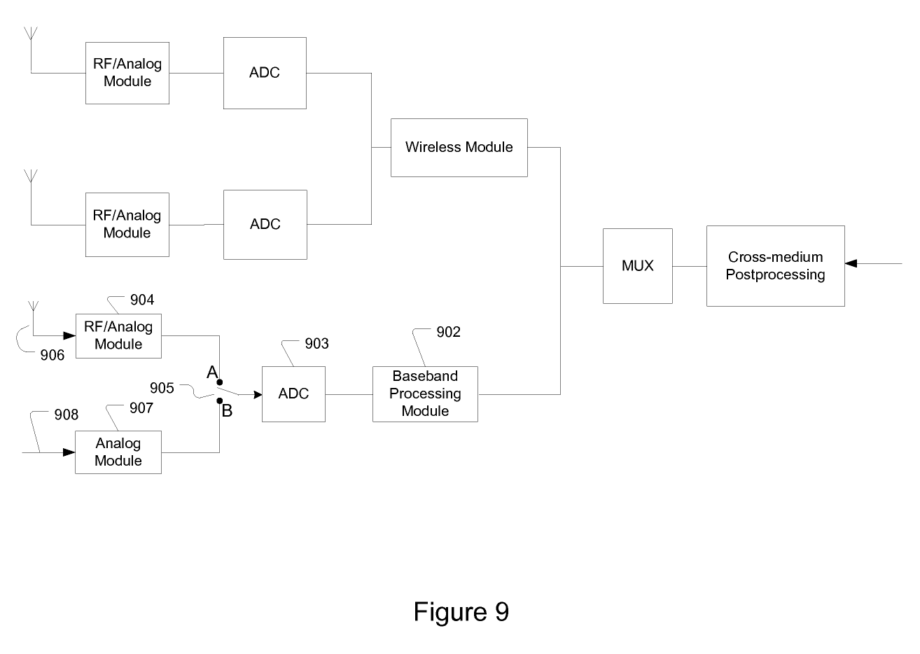

Similarly, in various embodiments, the device can be configured so that a data stream can be received at the receiver through any of a set of alternative paths. FIG. 9 illustrates an example of a transmitter where a data stream can be optionally received through a wireless medium or a wire-line medium. In the illustrated example, the structure and function of components other than components 902 through 908 can be analogous to the corresponding components and functions described in FIG. 4. As illustrated in the example, a switch 905 can be position on the “A” terminal to receive a data stream wirelessly through an antenna 906. The data stream can be conveyed from the antenna 906 to a RF/Analog module 904 where the data stream can be, for example, filtered, amplified and tuned to adjust signal frequency. The signal can be conveyed to an ADC 903 for digital conversion and to a baseband processing module 902, where the signal can be, for example, demodulated and further processed. The switch 905 can be position on the “B” terminal to receive a data stream through a wire-line 908. The data stream can be conveyed from to an Analog module 907 where the data stream can be, for example, filtered, amplified, and tuned to adjust signal frequency. The signal can be conveyed to the ADC 903 for digital conversion and to a baseband processing module 902, where the signal can be, for example, demodulated and further processed. In other embodiments, the device can be configured so that a data stream can be received through one of several paths. For example, a five way switch can be used to receive a data stream either wirelessly using MIMO transmission, wirelessly using SISO transmission, through a telephone line, through a power line, or through a coax cable. In an embodiment, the baseband processing module 902 can be programmable or configurable to accommodate different demodulation techniques mandated by different mediums and/or standards.

In various embodiments, a configurable transmitter, such as the example illustrated in FIG. 8 and a configurable receiver, such as the example illustrated in FIG. 9, can both be configured or can negotiate through a pre-determined protocol to use the same medium. For example, a transmitter, such as the example illustrated in FIG. 8, can be configured to transmit a data stream through a wireless medium instead of a wire medium. Accordingly, a corresponding receiver, such as the example illustrated in FIG. 9, can be configured; for example, either manually, through a pre-determined protocol, or otherwise, to receive the data stream through a wireless medium instead of a wire medium.

In various embodiments, the invention can be implemented as a communications bridge between different devices. For example, one device may be configured to communicate through a different medium than another device. More specifically, one device may be configured to communicate through a coaxial cable, while another device may be configured to communicate wirelessly, while another device may be configured to communicate through a telephone line. In various embodiments, the invention can comprise a bridging module to permit such devices to communicate with each other. Further, in various embodiments, the invention can comprise a bridging module to permit a single-medium communication device to communicate with a multi-medium communication device as described in this specification.

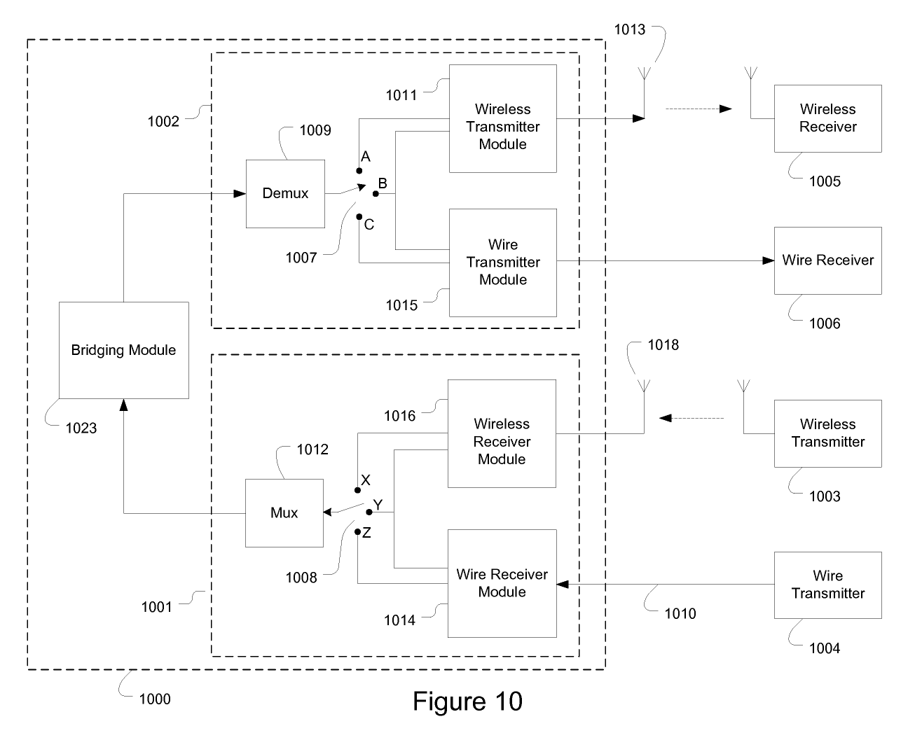

FIG. 10 illustrates an example of communication bridging between various devices, in accordance with various embodiments. A device 1000 can contain a receiver portion 1001, a transmitter portion 1002, and a bridging module 1023 connecting the receiver portion 1001 with the transmitter portion 1002. A wireless transmitter 1003 and a wire transmitter 1004 can communicate data to the device 1000. The wireless transmitter 1003 and the wire transmitter 1004 can be located either in separate devices or in the same device. The transmitter portion 1002 can communicate data to a wireless receiver 1005 and a wire receiver 1006. The wireless receiver 1003 and the wire receiver 1004 can be located either in separate devices or in the same device. A wire receiver module 1014 can receive a data stream from the wire transmitter 1004 and process the data stream, for example through filtering, analog to digital conversion, amplification, tuning, and/or demodulation before transmitting the data stream to other portions of the device 1000. A wireless receiver module 1016 can receive a signal from the wireless transmitter 1003 through an antenna 1018 and process the data stream, for example through filtering, analog to digital conversion, amplification, tuning, and/or demodulation before transmitting the data stream to other portions of the device 1000. A wireless transmitter module 1011 can receive a data stream from other parts of the device 1000 and process the data stream, for example through filtering, digital to analog conversion, amplification, tuning, and/or modulation before transmitting the data stream to the wireless receiver 1005. A wire transmitter module 1015 can receive a data stream from other parts of the device 1000 and process the data stream, for example through filtering, digital to analog conversion, amplification, tuning, and/or modulation before transmitting the data stream to the wire receiver 1006. By configuring switches 1007 and 1008, the device 1000 can bridge communication from either or both of transmitters 1003 and 1004 to either or both of receivers 1005 and 1006.

In various embodiments, the switch 1008 can be in the “Y” position and data can be transmitted to the receiver portion 1001 according to the multi-medium data transmission systems and methods described above, such as illustrated in the example of FIG. 4 and FIG. 5. For example, the wireless transmitter 1003 and the wire transmitter 1004 can transmit data sub-streams that were demuxed from a single data stream. The data streams from the wireless transmitter 1003 and the wire transmitter 1004 can be conveyed to the wireless receiver module 1016 and the wire receiver module 1014 respectively. From the wireless receiver module 1016 and the wire receiver module 1014, the streams can be conveyed to the mux 1012, where the data streams can be combined into one data stream as describe in more detail above.

In various embodiments, the switch 1007 can be in the “B” position and data can be transmitted from the transmitter portion 1002 according to the multi-medium data transmission systems and methods described above, such as illustrated in the example of FIG. 2 and FIG. 3. For example, a data stream can be separated into two data sub-streams in the transmitter portion 1002 such that one sub-stream can be conveyed to the wireless receiver 1005 and one sub-stream can be conveyed to the wire receiver 1006. Namely, a data stream can be separated into two sub-streams in a demux 1009, as describe in more detail above, one sub-stream can be conveyed to the wireless transmitter module 1011 to be communicated to the wireless receiver 1005 through an antenna 1013 and the other sub-stream can be conveyed to the wire transmitter module 1015 to be communicated to the wire receiver 1006. The data sub-streams received at the wireless receiver 1005 and the wire receiver 1006 can be muxed into a single data stream.

When switch 1008 is in the “Z” position and switch 1007 is in the “A” position, the wire transmitter 1004 can communicate with the wireless receiver 1005. Namely, a data stream from the wire transmitter 1004 can be conveyed through a wire medium 1010 to the receiver portion 1001. In the receiver portion 1001, the data stream can be conveyed to a wire receiver module 1014, through the switch 1008, through a mux 1012, to the bridging module 1023, and to the transmitter portion 1002. In the transmitter portion 1002, the signal can be conveyed through a demux 1009, through the switch 1007, to a wireless transmitter module 1011, and to an antenna 1013 for wireless transmission to the wireless receiver 1005.

When switch 1008 is in the “Y” position and switch 1007 is in the “A” position, then the wire transmitter 1004 and the wireless transmitter 1003 can communicate with the wireless receiver 1005. Namely, a data stream from the wire transmitter 1004 can be conveyed through a wire medium 1010 to a wire receiver module 1014 in the receiver portion 1001 and a data stream from a wire transmitter 1003 can be conveyed through an antenna 1018 to a wireless receiver module 1016 in the receiver portion 1001. The signal form the wireless receiver module 1016 and the signal from the wire receiver module 1014 can be conveyed to the switch 1008 and to a mux 1012, where the two streams can be combined into a single stream. The single stream can be conveyed to the bridging module 1023 and to the transmitter portion 1002. In the transmitter portion 1002, the signal can be conveyed through a demux 1009 and through the switch 1007 to a wireless transmitter module 1011, and to an antenna 1013 for wireless transmission to the wireless receiver 1005.

When switch 1008 is in the “X” position and switch 1007 is in the “A” position, then the wireless transmitter 1003 can communicate a data stream to the wireless receiver 1005.

When switch 1008 is in the “Z” position and switch 1007 is in the “B” position, the wire transmitter 1004 can communicate a data stream that can be demuxed into two sub-streams in the demux 1009 and one sub-stream can be communicated to the wireless receiver 1005 and the other sub-stream can be communicated to the wire receiver 1006.

When the switch 1008 is in the “Y” position and switch 1007 is in the “B” position, the wireless transmitter 1003 and the wire transmitter 1004 can communicate data streams that can be combined in the mux 1012 into a single data stream that can be communicated to and demuxed into two sub-streams in the demux 1009 and one sub-stream can be communicated to the wireless receiver 1005 and the other sub-stream can be communicated to the wire receiver 1006.

When the switch 1008 is in the “X” position and switch 1007 is in the “B” position, then the wireless transmitter 1003 can communicate a data stream which can be demuxed into two sub-streams in the demux 1009 and one sub-stream can be communicated to the wireless receiver 1005 and the other sub-stream can be communicated to the wire receiver 1006.

When switch 1008 is in the “Z” position and switch 1007 is in the “C” position, the wire transmitter 1004 can communicate a data stream to the wire receiver 1006.

When the switch 1008 is in the “Y” position and switch 1007 is in the “C” position, the wireless transmitter 1003 and the wire transmitter 1004 can communicate data streams that can be combined in the mux 1012 into a single data stream that can be communicated to the wire receiver 1006.

When the switch 1008 is in the “X” position and switch 1007 is in the “C” position, then the wireless transmitter 1003 can communicate a data stream to the wire receiver 1006.

While certain exemplary embodiments have been described and shown in the accompanying drawings, it is to be understood that such embodiments are merely illustrative of and not restrictive on the broad invention, and that this invention is not limited to the specific constructions and arrangements shown and described, since various other modifications may occur to those ordinarily skilled in the art. Accordingly, the specification and drawings are to be regarded in an illustrative rather than a restrictive sense.

Reference in the specification to “an embodiment,” “one embodiment,” “some embodiments,” “various embodiments” or “other embodiments” means that a particular feature, structure, or characteristic described in connection with the embodiments is included in at least some embodiments, but not necessarily all embodiments. References to “an embodiment,” “one embodiment,” or “some embodiments” are not necessarily all referring to the same embodiments. If the specification states a component, feature, structure, or characteristic “may,” “can,” “might,” or “could” be included, that particular component, feature, structure, or characteristic is not required to be included. If the specification or Claims refer to “a” or “an” element, that does not mean there is only one of the element. If the specification or Claims refer to an “additional” element, that does not preclude there being more than one of the additional element.

1. A method comprising:
receiving a data stream;
demuxing the data stream into a first sub-stream and a second sub-stream;
transmitting the first sub-stream to a receiver through a wireless medium; and
transmitting the second sub-stream to the receiver through a wire medium.

2. The method of claim 1, further comprising:
receiving the first sub-stream at the receiver;
receiving the second sub-stream at the receiver;
muxing the first sub-stream and the second sub-stream into a single stream.

3. The method of claim 1, further comprising performing cross-medium pre-processing of the signal prior to demuxing the data stream.

4. The method of claim 1, further comprising performing at least one of: STBC encoding, forward error correction encoding, and MIMO matrix encoding prior to demuxing the data stream.

5. The method of claim 1, where transmitting the first sub-stream to a receiver through a wireless medium comprises at least one of: MIMO transmission, SIMO transmission, and SISO transmission.

6. The method of claim 1, where the first sub-stream is transmitted to the receiver through MIMO transmission.

7. The method of claim 1, where transmitting the second sub-stream to the receiver through a wire medium comprises at least one of: telephone line transmission, power line transmission, and coaxial cable transmission.

8. The method of claim 1, further comprising transmitting the second sub-stream to the receiver through a wireless medium instead of the wire medium.

9. a method comprising:
receiving at a receiver a first sub-stream through a wireless medium;
receiving at the receiver a second sub-stream through a wire medium;
muxing the first sub-stream and the second sub-stream into a single stream.

10. The method of claim 9, where the first sub-stream and the second sub-stream are received from a transmitter after the first sub-stream and the second sub-stream are demuxed from a single data stream in the transmitter.

11. The method of claim 9, further comprising performing at least one of: STBC decoding, forward error correction decoding, and MIMO matrix decoding after muxing the data stream.

12. The method of claim 9, where the first sub-stream is received at the receiver through at least one of: MIMO transmission, SIMO transmission, and SISO transmission.

13. The method of claim 9, where receiving the second sub-stream at the receiver comprises at least one of: telephone line transmission, power line transmission, and coaxial cable transmission.

14. An apparatus comprising:
a demuxing unit for demuxing a received data stream into a first sub-stream and a second sub-stream;
a wireless module for transmitting the first sub-stream to a receiver through a wireless medium; and
a wire module for transmitting the second sub-stream to the receiver through a wire medium.

15. The apparatus of claim 14, further comprising:
a wireless module for receiving a third sub-stream through a wireless medium;
a wire module for receiving a fourth sub-stream through a wire medium; and
a muxing unit for muxing the first sub-stream and the second sub-stream into a single data stream.

16. The apparatus of claim 14, further comprising a bridging module configurable to make at least one of the connections:
the wire receiver module to the wireless transmitter module,
the wire receiver module to the wire transmitter module,
the wire receiver module to the wire transmitter module and the wireless transmitter module,
the wireless receiver module to the wireless transmitter module,
the wireless receiver module to the wire transmitter module,
the wireless receiver module to the wire transmitter module and the wireless transmitter module,
the wire receiver module and the wireless receiver module to the wire transmitter module,
the wire receiver module and the wireless receiver module to the wireless transmitter module, and
the wire receiver module and the wireless receiver module to the wire transmitter module and the wireless transmitter module.

17. The apparatus of claim 14, further comprising a pre-processing module for performing at least one of: STBC coding, forward error correction encoding, and MIMO matrix encoding prior to demuxing the data stream.

18. The apparatus of claim 14, where the wireless module is configured to transmit the first sub-stream through at least one of: MIMO transmission, SIMO transmission, and SISO transmission.

19. The apparatus of claim 14, where the wire module is configured to transmit the second sub-stream through at least one of: telephone line transmission, power line transmission, and coaxial cable transmission.

20. The apparatus of claim 14, further comprising a second wireless module for transmitting the second sub-stream to the receiver through a wireless medium, where the apparatus is configurable to transmit the second sub-stream to the receiver through either the second wireless module or the wire module.
